(19) United States
(12) Patent Application Publication
(10) Pub. No.: US 2004/0028317 A1
(43) Pub. Date: Feb. 12, 2004

(54) Network design allowing for the delivery of high capacity data in numerous simultaneous streams, such as video streams

(76) Inventor: Robert McLean, Stamford, CT (US)

Correspondence Address: Richard J Danyko, Scully Scott Murphy and Presser, 400 Garden City Plaza, Garden City, NY, 11530, US

(21) Appl. No.: 10/432,078

(22) PCT Filed: Nov. 20, 2001
(86) PCT No.: PCT/US01/43258

(51) Int. Cl. G02B 6/26; G02B 6/42

(52) U.S. Cl. 385/16

(57) ABSTRACT

The present invention is further directed to a method of deploying an extremely high-capacity network optimized for delivery of broadband video that exploits the best features of the centralized server architecture and the distributed server architecture, while overcoming the largest problems created by each. This hybrid architecture allows for the optimal exploitation of networking capital assets while the same time minimizing support, connectivity, and facilities costs.

### FIELD OF THE INVENTION

This present invention is directed to a network design drawing upon a configuration of commercially available, or soon-to-be-available networking equipment to overcome significant barriers to the widespread use of IP network-based high quality video streaming and video conferencing, at onsite locations, such as within a corporate office. The present invention is further directed to a method of deploying an extremely high-capacity network optimized for delivery of broadband video via the Internet that exploits the best features of the centralized server architecture and the distributed server architecture, while overcoming the largest problems created by each. This hybrid architecture allows for the optimal exploitation of networking capital assets while at the same time minimizing support, connectivity, and facilities costs. The present invention is further directed to a method of deploying a global-reach router-based network on a Dense Wave Division Multiplexer (DWDM) infrastructure that allows all routers to be centrally located.

### BACKGROUND OF THE INVENTION

Corporate connections to the Internet almost always lack sufficient capacity to support more than a few simultaneous high-quality Internet-delivered video streams to users who are connected to the corporate network.

Directly connecting corporate clients to a private streaming network via discrete, dedicated communications circuits, bypassing the Internet, to overcome this problem is inefficient and cumbersome. It also often requires several telephone companies to be involved in each circuit's provisioning and reliability for a circuit of 40 miles or longer. Costs increase in direct proportion to the circuit mileage, making it economically unfeasible to uniformly support remote regions with a dedicated circuit service.

Also, there are problems with distributed server architecture streaming video networks, which make use of streaming servers geographically distributed throughout the U.S. and the world. Such networks are difficult to maintain. Replicating content to many remotely located servers is time consuming and inefficient. Furthermore, devising a system that assigns a user to a particular group of video servers that will offer the best performance for said user presents several challenges.

Problems may arise during typical implementations of the Centralized Server streaming network architecture. To give an example, the costs for the high-speed circuits connecting the network core to each of the largest IP backbones are distance-sensitive. Therefore, these circuits usually connect to the nearest node capable of handling the capacity. Video quality degrades with distance from the network core. The video streams cross more routers throughout the Internet en route to the viewer, and are much more vulnerable to network congestion.

Further, there are problems associated with traditional backbone network architectures typical of Internet backbone networks. These architectures cannot be scaled up effectively to accommodate the growing use of multimedia streaming files and high-resolution video conferencing, both of which require unimpeded, reliable throughput from the source to the viewer. Data passes through many routers along the path between user and server.

Video streaming content is presently delivered via the Internet. Video Streaming networks are logical and physical entities that support servers to which viewers connect to pull down multimedia files. Streaming Networks fall into either the Distributed or Centralized Server Architecture categories.

Distributed Architecture streaming networks place servers in geographically diverse “co-location facilities” or in rented space in equipment racks belonging to Internet Service Providers, cable modem providers, or Digital Subscriber Line (DSL) providers. This places them closer to the viewer, which can be referred to as the “last mile” of the Internet route. Some Distributed Architecture streaming networks' POPs (Points of Presence) contain networking equipment to which the servers connect, and which connects directly to the ISP or broadband provider. Other Distributed Architecture networks' POPs consist of only one or more servers connected to Co-location Facility network equipment.

Centralized Architecture Streaming Networks consist of streaming servers located in one data center on a network that connects to the Internet via a few to several high-speed circuits to different Tier 1 ISP backbones. This distributes streaming traffic across the largest capacity backbone networks that connect to Tier 2 ISPs, cable modem and DSL providers, and corporate networks.

There is one company known at present, Digital Pipe, that offers to install and manage video servers on Corporate Intranets. Content is posted via the company's Internet connection, and remote management must be performed via the same Internet connection. Another company, Eloquent, sells Streaming Systems for Corporate Intranets that are customer-managed.

Some regional distance learning networks have been built that directly connect participating sites via high-speed ATM or T-1 circuits. These networks bypass the Internet by using a commercially available ATM network or point-to-point circuits. These are largely videoconferencing applications that require all participants to sit in one room in front of a camera. It would be possible for these networks to provide on-demand streaming from a video server to the participating sites, but only those sites would be able to access the content.

While this system may work for client sites, the audience cannot grow to include the vast potential marketplace (regional national and global) for the content. Moreover, in-house personnel would have to learn virtually every aspect of streaming video and invest in the equipment to effectively implement on-demand streaming over these private networks. Connecting with existing ATM is troubled with relatively expensive network offerings. Expanding these private networks or opening them to wider audiences involves significant cost increases and connecting them to the Internet, respectively.

Distributed Router-Based Internet Backbone Network

High-speed telecommunications networks links connect routers based in different cities. Routers for these networks are deployed in rented or carrier-owned space in cities around the globe. In some cases, dense wave division multiplexer (DWDM) gear is used to provide higher speed circuits or multiple circuits between routers at each end of the fiber runs. The routers at each of the major backbone nodes connect to other routers in logical, hierarchical tiers that extend towards customer locations, effectively aggregating those connections. Traffic between East and West Coast locations passes through several routers.

Many of the problems associated with the streaming network designs derive from the “last mile” of the Internet connection, because a corporate network's Internet connection cannot be cost effectively scaled to accommodate several simultaneous high-quality video streams. For example, a T-1 circuit to the Internet can accommodate five 300 Kbps video streams under ideal conditions. A DS3 connecting to the Internet at 45 Mbps can cost as much as $30,000/month, and accommodate only 150 simultaneous 300 Kbps viewers under ideal conditions.

Internet Service Providers have not enabled IP Multicast on their backbones. Multicast would allow many viewers in one location to watch one source video stream for scheduled broadcast-style events. Even if multicast becomes available on a new Internet backbone, or existing Internet backbones become multicast-enabled, the legacy installations and connections will require years of work to upgrade.

There are disadvantages associated with existing Distributed Server Architecture streaming networks. On-demand content has to be replicated in nearly every server, or at a minimum, in one server in every POP to realize the optimal performance of this architecture. Content replication to many remotely located servers is time consuming and inefficient. Assuring quality of distributed content at every POP is also time-consuming and difficult. Determining the optimal server for each viewer attempting to view content presents many challenges. Several variables affect the selection process. For example, instantaneous response time from server to viewer PC is one criteria. However, this does not consider the best, fewest router-hop path between the two. It is possible for a viewer in New York City to be assigned to a server in a POP in Chicago in one instant, and a viewer in Chicago (through an Internet connection terminating in Chicago) to be assigned to a server in a POP in NYC the next. This can lead to inefficient and unnecessary loading of Internet backbone links.

“Trace routes” performed from servers to the viewer may reveal a path with the fewest router hops, but not account for a learned path that crosses ISP peering points which typically degrade video quality due to high utilization. BGP route table-based decisions require a router in every POP capable of receiving full routes from the ISPs, and a device or software program that can query those routers for each viewer redirection. This may be economically feasible in Streaming Networks with several servers in fewer large hops, but not where hundreds of POPs consist of a few servers. Also, co-location facilities are typically set up to host servers more easily than routers requiring BGP sessions with neighboring routers. The size of the BGP route table is growing constantly, and requires more powerful routers to maintain BGP sessions and receive the entire Internet routing table and all updates to it. A niche in the networking equipment industry constantly tries to address the redirection optimization challenges associated with distributed groups of servers.

Further, there are disadvantages associated with the Centralized Server Architecture streaming network. The Centralized Server Architecture fixes many problems inherent in the Distributed model. However, connecting the core site with sufficient capacity to support many simultaneous viewers proves challenging and expensive. The monthly circuit costs are distance-sensitive, and high-capacity circuits are expensive in general. Several connections to all the Tier 1 Internet backbones would require several high-speed circuits. Connecting to multiple backbones greatly reduces the reliance on the ISP-to-ISP peer network connections. Centralized architecture networks rarely, if ever, connect to geographically distant, smaller ISPs to reduce reliance on the ISP-to-ISP peering circuits.

Video quality degrades with distance from the network core. The video streams cross more routers throughout the Internet en route to the viewer, and are much more vulnerable to network congestion. Crossing ISP-to-ISP peering points renders a stream extremely vulnerable to disruptive network congestion.

Further, there are disadvantages associated with distributed router networks. Router configurations are not optimized, resulting in over or under-subscription of available processing power. Local requirements vary by demand, rendering optimization nearly impossible. Inter-city links between routers can become oversubscribed, forcing upgrades to routers at each end of the link, even when the customer-facing interfaces are not over-utilized. A router in the middle of a connection to two others can also become a weak link in a standard deployment, overrun by traffic flowing between two of its immediate neighbors. Even as traffic flows across a typical backbone network under ideal conditions, it is buffered and re-transmitted by every router in its path. This can disrupt the quality of video streams, as streaming video player software is very sensitive to disruptions in the source stream.

The only known offering of corporate Intranet-based video streaming relies on the Internet connection for content replication to, and management of, the video server. This offering will support on-demand viewing well for workstations connected to the corporate Intranet, but not broadcast style, “live” video. It also will not support video for work-at-home viewers via the Internet without adversely affecting the corporate network Internet connection. The last mile dilemma will be reversed. It also will not be able to support any additional services such as video conferencing, or Voice-over-IP.

### SUMMARY OF THE INVENTION

The present invention is a network design that employs centralized servers and routers, and massively distributed connectivity to Internet backbones, last mile providers, and private networks. This network design, an embodiment of which is shown in the attached FIG. 1, simplifies connecting a streaming network to a terminal location, such as a corporate network, while optimizing utilization of routers and servers that deliver video to Internet-based viewers.

This network employs a Dense Wave Division Multiplexing (DWDM) Infrastructure on a pair of dark fiber optic cables across the U.S. and eventually, the globe. Access to a dark fiber overlay of a tier one ISP and the services of a telecommunications company such as Level 3 or Broadwing speeds implementation. Either fiber optic infrastructure passes through many “telecom hotels” in major US cities where other ISPs also terminate their fiber cables, install networking equipment, and connect to each other's networks.

The network infrastructure includes, or may include (1) DWDM equipment, which in one embodiment is located in a network center; (2) can further multiplex four OC-12 interfaces onto each OC-48 wavelength; (3) additional multiplexing equipment to aggregate lower speed circuits such as OC-3 and/or DS-3 to OC-12 or OC-48 speeds, if required, (3) optical add/drop multiplexers in every co-location facility/telecom hotel through which the fiber passes, (4) optical regeneration amplifiers installed in small buildings every 80 to 100 Km of fiber cable length between co-location facilities, as required; (5) one to four OC-48 wavelengths provisioned for each location; (6) multiplexer interfaces that mirror the four OC-12 interfaces per OC-48 in the Network Center, creating four to sixteen OC-12s in the OADM in the co-location facility; (7) additional multiplexing equipment to aggregate lower speed circuits such as OC-3 and/or DS-3 to OC-12 or OC-48 speeds, if required to match those in the Network Center; (8) additional wavelengths pass through to the next location where another one to four OC-48 wavelengths terminate to mux cards for four to sixteen OC-12s in the OADM; (9) routers, switches, local load balancing switches in the Network Center; (10) streaming servers, storage area network disk arrays in the Network Center. Suitable DWDM equipment includes, but is not limited to, Ciena Core Stream, Nortel Optera, and Cisco Systems Optical Networks.

### BRIEF DESCRIPTION OF THE DRAWINGS

FIG. 1 shows a configuration of an embodiment of the present invention.

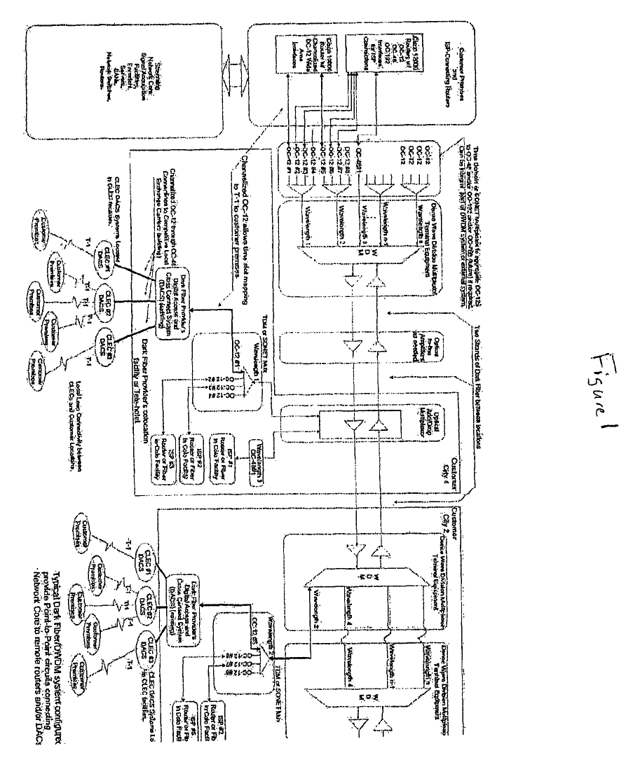

FIG. 2 shows a configuration of an embodiment of the present invention including detail of customer premises.

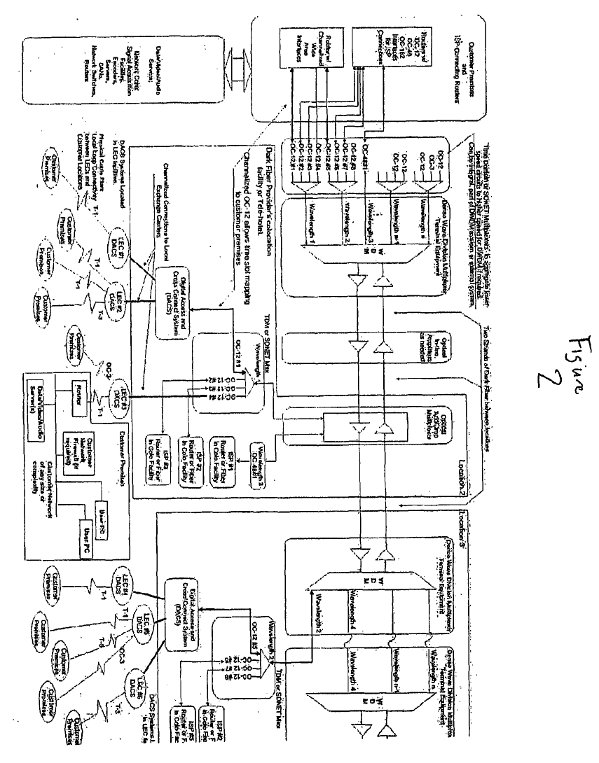

FIG. 3 shows a configuration of an embodiment of the present invention including detail of optical switches.

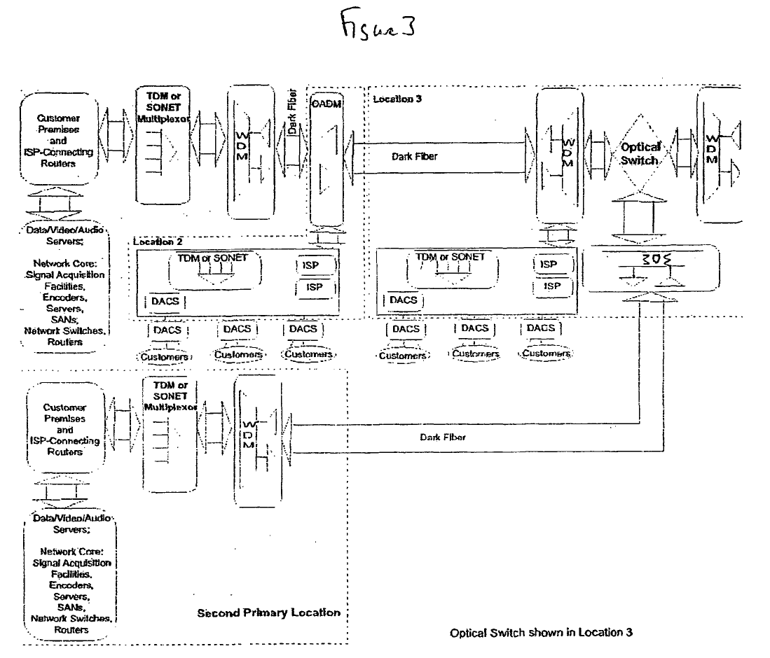

### DETAILED DESCRIPTION OF THE PREFERRED EMBODIMENT

Content intended for video streaming is acquired at the network center through tape ingest or satellite feeds. The content is encoded, i.e., digitized and compressed, by devices known as Encoders, which are well known in the art, into formats suitable for streaming. Such archived content for on-demand viewing is stored on disk in the SAN. Distribution servers connect to Encoders to “split” Broadcast Content to multiple streaming servers. Streaming Servers connect to the distribution servers via a back channel network interface.

Streaming servers connect via a primary interface to the network to which they will deliver user video streams. Cisco 12000 series, such as 12012 or 12016 Gigabit Switch Routers, connect to the Streaming Server subnets and have OC-12 interfaces that will connect to Internet Service Provider Backbones (greater capacities are available, such as OC-48 and OC-192. It is expected that even greater capacities will become available in the future.) Viewers connect to the streaming servers to view content via the Internet connections to the Cisco 12000 series routers.

Hybrid Network Design for Internet-delivered services is also possible. The DWDM infrastructure is used to extend the interfaces of the centrally located routers to every city in which the OADM or DWDM gear is installed. Connections to ISP Backbones are made within the Tele-hotels via “inside wiring” between the ISP interface and the OADM or DWDM port. In cities where the fiber terminates in a provider-owned co-location facility, but not a Tele-hotel, short, intra-city local loops connect to other ISP backbones where possible. Connections are made directly via “inside wiring” to each and every DSL or last mile provider co-locating equipment in the same facility as the OADM. This bypasses Internet backbones and their existing traffic in connecting to high-speed access providers' equipment. This achieves the same result as placing video servers “close” to the last mile in co-location facilities, while maintaining all servers providing content via the Internet in one central location.

Every connection to an ISP backbone or last mile provider terminates in the same room as every other, the Network Center. Hundreds of points of connectivity can be brought back to the Network Center. Router configurations can be optimized, router maintenance simplified, and new circuits connected to any router with available capacity, without regard for the geographic location of the distant end point. The centrally located routers route traffic to viewers trying to use services supported by this network via the user's Internet connection.

The end user, such as a corporate customer, can have their network interfaced to this network by Cisco 10000 Series Enterprise Switch Routers (ESR) connected via Gigabit Ethernet interfaces to the Streaming Server Primary interface subnets in the Network Center. These ESRs are additionally equipped with channelized OC-12 Interface Processors. Each channelized OC-12 interface connects to an OC-12 port on the DWDM gear such as Ciena Core Stream. Each OC-12 router port is extended to a different co-location facility, and therefore, different city, via the DWDM infrastructure. At each co-location facility, the interface on the OADM or DWDM equipment corresponding to the Channelized OC-12 router interface connects to a Digital Access and Cross-Connect system (DACS) channelized OC-12 port via “inside wiring.” The DACS could be available from Level 3, Broadwing, or Williams, to name a few. Presently, DACS are already connected to Local Exchange Carriers via channelized OC-12 to OC-48 circuits to support traditional telecommunications businesses. T-1 telecommunications circuits (1.544 Mbps) are provisioned to corporate customer networks through the LEC. Each T-1 circuit is assigned to a time slot, or channel, of the Channelized OC-12 interface. The customer side of the circuit terminates on a router owned by the Multimedia Network Provider. IP addressing, routing, Network Address Translation (NAT) (if required) parameters are configured in the Network Center routers and the Customer Premises router to allow the routers in the Network Center to prefer the route to the customer network to be via the channelized OC-12 and provisioned T-1 circuit. A secondary route to the customer network may be provided as the customer's Internet connection. Three hundred thirty-six customer premises T-1s can be provisioned for each Channelized OC-12 interface in the Network Center. This allows up to 336 customers in one city or within a local radius of the co-location facility to connect directly to this Network at T-1 speeds, over which streaming video can be provided. Cost to connect each customer is minimized. Multiple customers connected to the channelized OC-12 reduce per-customer interface cost.

Video can be delivered to corporate network users on on-demand. A configured video server can be installed on the same subnet as the customer-premises router or elsewhere within the corporate Intranet. Encoded content can be delivered via FTP from the network center to the customer-premises video server via the “private” T-1 link. In operation, a customer Intranet web master posts a fully qualified URL for the video content on the internal company Intranet web server. Viewers connect to the video server and pull streams through the link. Customer Intranet web master posts, on the customer's external web server, a fully qualified URL for the same video content resident on Video Servers in the Network Center. Work-at-home and satellite office employees can view video streamed from the Network Center via their Internet connections. Corporate network-based viewers access the customer-specific video through a 10 Mbps, 100 Mbps, or 1000 Mbps connected server on the local network. Many more users can view content simultaneously as opposed to through a standard Internet connection.

Again, broadcast, or “live” content is encoded in content streams that are multicast to the network. Remote customer-premises routers are programmed to receive and route multicast streams. Corporate viewers attach to the multicast stream at the router through a standard URL if the corporate network supports multicast. It is possible that if the local area network supports multicast, thousands of viewers can simultaneously view the content.

It is also possible to have distribution servers multicast or broadcast (via unicast) live video streams to the remote customer-premises video servers from the private streaming or multimedia network. In this arrangement, users pull unicast streams from the server via a fully qualified URL. The remote server is configured as a distribution server to support this.

The direct connections to the Multimedia Network can be used to support high-resolution video conferencing to other sites directly connected to the Multimedia Network or the Internet. Customer-owned or Multimedia Network-provided IP-capable video conferencing equipment connects to the same subnet as the customer-premises router, or to the corporate network. Multicast support on the Multimedia Network allows multiple sites to participate in a single video conference. Two-party video conferencing to anywhere is supported via the multimedia network's highly distributed connectivity to Internet Backbone networks. The bandwidth available to the Internet-based videoconference party may adversely affect quality. Two party conferences wherein both sites are connected directly to the Multimedia Network may achieve extraordinary quality.

The direct connections to the Multimedia Network can be used to support Voice-over-IP phone calls between sites or anywhere. The customer-premises routers can be provisioned to support VoIP. Existing Private Branch Extension (PBX) phone systems can connect analog or digital trunks directly to properly equipped and configured customer-premises routers which convert the circuit-based calls to IP packet calls. Such a possible customer-premises router may be, but is not limited to, a Cisco 3600 series router. A customer of the customer-premises based video server service with many satellite locations, such as, but not limited to, an automobile manufacturer with routers and video servers in every dealership, can realize significant savings on dealer-to corporate phone calls.

The various components of the network described and illustrated in the embodiments of the invention discussed above may be modified and varied in light of the above teachings.

I claim:

1. A network infrastructure for interconnecting two or more remote destinations via optical data links, wherein the optical data links are comprised of a plurality of electromagnetic wavelengths, comprised of:
a DWDM in a first location interfaced with dark fiber optic cable for transmitting an optical signal that includes a plurality of wavelengths across the dark fiber, the DWDM having an input for receiving a plurality of data connections and an output for transmitting the data connections in dedicated wavelengths across the dark fiber,
an optical multiplexor in a second location interfaced with the first DWDM via the dark fiber, wherein at least one wavelength is output from the network infrastructure in the second location optical multiplexor.

2. The network infrastructure according to claim 1 further comprised of at least one additional optical multiplexor located in another location wherein at least one additional wavelength is output.

3. The network infrastructure of claim 1 wherein the second location optical multiplexor is an optical add-drop multiplexor.

4. The network infrastructure of claim 1 wherein the second location optical multiplexor is a dense wave division multiplexor.

5. The network infrastructure of claim 3 wherein the second location multiplexor is interfaced to a DACS system.

6. The network infrastructure of claim 4 wherein the second location multiplexor is interfaced to a DACS system.

7. The network infrastructure of claim 1 wherein the optical multiplexor in the second location is interfaced to a multiplexor selected from time domain multiplexor or SONET multiplexor.

8. The network infrastructure of claim 7 wherein the multiplexor selected from TDM or SONET connects to a corresponding TDM or SONET multiplexor located in the first location via wavelengths on the DWDM span.

9. The network infrastructure of claim 7 wherein the multiplexor selected from time domain multiplexor or SONET multiplexor is interfaced to a DACS system in a Local Exchange Carrier.

10. The network infrastructure of claim 5 wherein the DACS system is located in Local Exchange Carrier facilities.

11. The network infrastructure of claim 6 wherein the DACS system is located in LEC facilities.

12. The network infrastructure of claim 9 wherein the DACS system is located in LEC facilities.

13. The network infrastructure of claim 10 wherein the DACS system located in LEC facilities is interfaced to the cabling plant connecting to the premises of end users.

14. The network infrastructure of claim 11 wherein the DACS system located in LEC facilities is interfaced to the cabling plant connecting to the premises of end users.

15. The network infrastructure of claim 12 wherein the DACS system located in LEC facilities is interfaced to the cabling plant connecting to the premises of end users.

16. The network infrastructure of claims 13, 14,and 15 wherein Local Exchange Carriers aggregate lower speed circuits from customer premises onto higher speed channelized circuits through the DACS.

17. The network infrastructure according to claim 1 further comprised of N additional optical multiplexors in at least a third location connected by dark fiber wherein all wavelengths designated for output in the third through Nth locations pass through the second location, wherein N is a whole number greater than equal to 3.

18. The network infrastructure according to claim 17 wherein wavelengths designated for output in the Nth location pass through the multiplexor in the N-1th location.

19. The network infrastructure according to claim 17 where N is greater than or equal to 4 and the network infrastructure is further comprised of an optical multiplexor in the fourth location wherein wavelengths designated for output in the fourth through Nth locations pass through the multiplexor in the third location.

20. A network connecting a primary locationand a remote location, comprising:
A primary location including routers;
a remote location; and
A routerless network infrastructure connecting the primary location to the at least one remote location, including a DWDM infrastructure that transmits data via optical circuits, wherein the primary location is connected to remote locations by discreet wavelengths.

21. The network of claim 20 further comprised of a plurality of remote locations.

22. The network of claim 1 wherein the remote location is an ISP.

23. The network of claim 1 wherein the remote location is a customer premises.

24. The network of claim 1 wherein the remote location is provided with a router.

25. The network of claim 20 wherein routers in the primary location connect to the remote LEC DACS systems with channelized interfaces.

26. The network infrastructure of claim 20 further comprised of a second primary location that is connected to the routerless network.

27. The network infrastructure of claim 20 wherein DWDM systems are interfaced with optical switches in remote locations.

28. The network infrastructure of claim 27 wherein the Optical Switches switch all wavelengths to the second primary site upon connection failure to the first primary site.

29. The network infrastructure of claim 1 wherein the first location is further comprised of data/video/audio servers.

30. The network of claim 29 wherein the data/video/audio servers in the primary location are interfaced to the routers of claim 21.

31. The network of claim 23 further comprised of data/video/audio servers installed in customer premises.

32. The network of claim 31 wherein the data/video/audio servers are interfaced to the network in the customer premises.

33. The network of claim 31 wherein users interfaced to the customer premises network receive/download data directly from the local servers.

34. The network of claim 31 wherein the servers installed in the customer premises receive and retransmit broadcast multimedia data from the servers of claim 29.

35. The network of claim 24 wherein the routers are configured to transmit multicast traffic.

36. The network of claim 31 wherein the data/video/audio servers are managed and monitored directly from the first location.
